(19) United States
(12) Patent Application Publication
(10) Pub. No.: US 2004/0228232 A1
(43) Pub. Date: Nov. 18, 2004

(54) Device for controlling focusing of light beam

(75) Inventors: Kazuo Takahashi, Tsurugashima-shi (JP); Kiyoshi Tateishi, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/834,234

(22) Filed: Apr. 29, 2004

(30) Foreign Application Priority Data
May 15, 2003 (JP) 2003-137260

(51) Int. Cl. G11B 7/00

(52) U.S. Cl. 369/44.26; 369/44.27

(57) ABSTRACT

A control device includes an a focus controller for performing a focus servo control and a focus jump control; an aberration corrector; a command generator for commanding the change of a recording/reading layer from one recording layer to the other layer; a portion for changing an aberration correction value to a value suited for the other recording layer; and a timing adjuster for adjusting an execution timing of the focus jump and a rate of change in the gain of the amplifier in such a manner that a timing when the gain of the amplifier reaches the predetermined gain is within the execution time period of the focus jump.

### BACKGROUND OF THE INVENTION

1. Field of the Invention

The present invention relates to a control device for controlling the focusing of a light beam, which is applied to an optical recording medium having a plurality of recording layers, and the like.

2. Description of the Related Art

Research and development on a high-density and large-capacity information recording medium have been aggressively conducted with the progress of information communication technology in recent years. Such recording medium includes an optical recording medium, a magnetic recording medium and the like. As the optical recording medium, for example, an optical disc such as a CD (Compact Disc), a DVD (Digital Versatile Disc) and the like is known. An optical disc using a blue-violet laser as a light source, for example, a Blu-ray Disc has been actively researched and developed as a next-generation large-capacity optical disc. In such optical disc, providing a plurality of recording layers in one recording surface (one side) (a multi-layer optical disc) increases recording capacity per recording surface, so that it is possible to further increase the capacity of the optical disc.

The multi-layer optical disc has a structure in which the plurality of recording layers are formed. The structure of the multi-layer optical disc will be here in after described with taking, for example, a double-layer DVD having two recording layers as an example. The two recording layers are formed so as to be separated from each other at relatively short distance by a spacer layer (or a cover layer). These recording layers are referred to as the first recording layer (hereinafter, simply referred to as “the first layer”) or a layer 0 (L0), and the second recording layer (hereinafter, simply referred to as “the second layer”) or a layer 1 (L1), in order of increasing distance from a disc surface (that is, from an optical pickup).

With progress in the development of the high-density and large-capacity optical disc like this, the development of an optical pickup device with higher precision and higher performance is desired.

In recording/reproducing data on/from the above-described optical disc having a plurality of recording layers, a laser light beam is focused on any one of the recording layers to record/reproduce a signal on/from the recording layer. There is a case where the focusing position of the irradiating light beam is changed from one recording layer to the other recording layer during a recording or reproduction operation. The transfer of the focusing position (i.e., recording or reading position) of the irradiating light beam between the recording layers for the purpose of recording or reading is generally called an interlayer jump or a focus jump. It is desired, as described above, to develop the optical pickup device and an optical pickup control device with higher precision and higher stability, which can correspond to shortening in the wavelength of the light beam, and increase in the NA (Numerical Aperture) of an objective lens.

Some conventional pickup devices carrying out the focus jump have means for switching the control gain of a focus servo during the focus jump (refer to, for example, Japanese Patent Laid-Open Publication Kokai No. H11-161977).

In the interlayer jump, however, aberration occurs in the light beam. The aberration, causing variation in the amplitude of a focus error signal, has the adverse effect of making the control of the focus servo unstable. When using aberration correction means such as a beam expander, a liquid crystal device or the like, there occurs a problem caused by the time delay of aberration correction. In other words, if the focusing position is transferred to the target recording layer, large residual aberration still remains. Therefore, there occur various problems that decrease in the gain of focus error tends to cause deviation in timing, and also makes the interlayer jump sensitive to external perturbations. The focus cannot be pulled-in to the target recording layer at worst.

Therefore, it is important to develop a high-performance focusing control device which can carry out the stable interlayer jump without any adverse effect described above.

### SUMMARY OF THE INVENTION

The present invention has been made in view of the foregoing problems, and it is an object of the present invention to provide a high-performance focusing control device which can carry out a stable interlayer jump without having an adverse effect due to the aberration of a light beam.

According to the present invention, there is provided a control device for executing a focus jump, the focus jump transferring a focusing position of a light beam applied to an optical recording medium having a plurality of recording layers from one recording layer to the other recording layer, the control device comprises an error signal generator for generating a positional error signal, the positional error signal representing the error between the focusing position of the light beam and a focusing target position of the optical recording medium; an amplifier for amplifying the positional error signal; a focus controller for performing a servo control of the focusing position of the light beam and the control of the focus jump, on the basis of the amplified positional error signal; an aberration corrector for correcting an aberration of the light beam; a layer change command generator for generating a layer change command, the layer change command commanding the change of a recording/reading layer from the one recording layer to the other recording layer; an aberration correction changing portion for changing an aberration correction value of the aberration corrector to an aberration correction value suited for the other recording layer, in response to the layer change command; and a timing adjuster for increasing a gain of the amplifier to a predetermined gain in response to the layer change command, and for adjusting an execution timing of the focus jump and a rate of change in the gain of the amplifier in such a manner that a timing when the gain of the amplifier reaches the predetermined gain is within the execution time period of the focus jump.

### BRIEF DESCRIPTION OF THE DRAWINGS

FIG. 1 is a block diagram showing the configuration of a focusing control device according to the present invention;

FIG. 2 is a flow chart showing the procedure of focus control (I) by the focusing control device according to a first embodiment of the present invention;

FIG. 3 is a timing chart showing the operation of the focus control (I);

FIG. 4 is a flow chart showing the procedure of focus control (II) by a focusing control device according to a second embodiment of the present invention;

FIG. 5 is a timing chart showing the operation of the focus control (II);

FIG. 6 is a flow chart showing the procedure of focus control (III) by a focusing control device according to a third embodiment of the present invention;

FIG. 7 is a timing chart showing the operation of the focus control (III);

FIG. 8 is a flow chart showing the procedure of focus control (IV) by a focusing control device according to a fourth embodiment of the present invention; and

FIG. 9 is a flow chart showing an example of the procedure of focus control by a focusing control device according to a fifth embodiment of the present invention.

### DETAILED DESCRIPTION OF THE INVENTION

Embodiments of the present invention will be hereinafter described in detail with reference to the accompanying drawings. In the embodiments hereinafter described, the same reference numerals refer to identical or equivalent components.

### FIRST EMBODIMENT

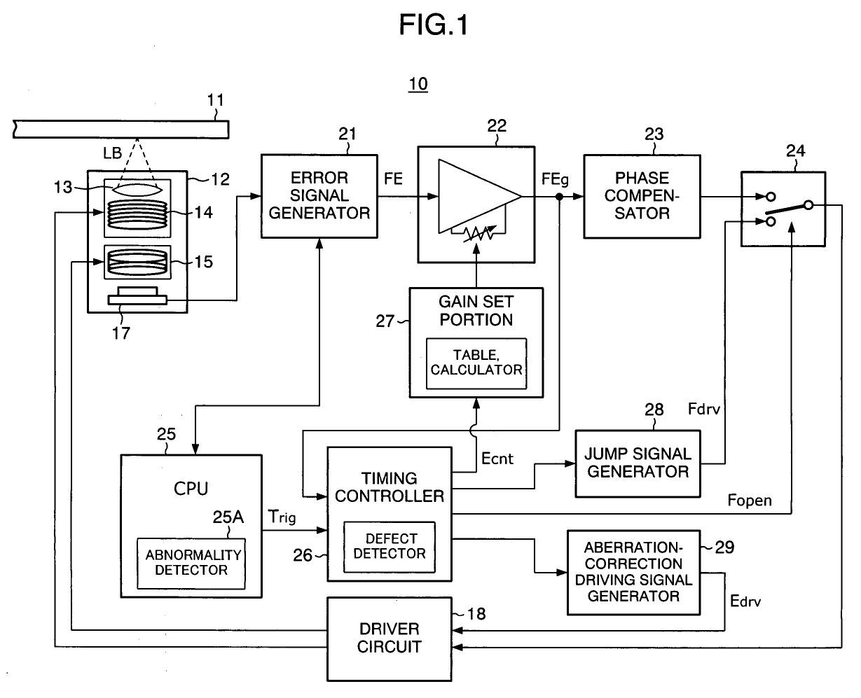

FIG. 1 is a block diagram showing the configuration of a focusing control device 10 according to a first embodiment of the present invention. The focusing control device 10 controls the focusing position of a light beam, which is used for recording/reading data on/from an optical disc 11. The structure of the focusing control device 10 will be hereinafter described in detail.

An optical pickup 12 has a laser light source (not illustrated) for emitting a light beam (LB), and an objective lens 13. The objective lens 13 focuses the light beam from the laser light source on a recording layer of the optical disc 11. The optical pickup 12 is provided with a focus actuator 14 for driving the objective lens 13. The optical pickup 12 is also provided with an aberration correction device 15 for correcting the aberration of the light beam, and a photodetector 17. The light beam reflected by the optical disc 11 is condensed by the objective lens 13, and received by the photodetector 17.

The optical pickup 12 is provided with a tracking actuator and a slider motor (not illustrated) for driving the optical pickup 12.

The focus actuator 14, the tracking actuator, the slider motor, and the aberration correction device 15 described above are driven by a driver circuit 18 under the control of a central processing unit (CPU) 25 described later on.

The aberration correction device 15 corrects the aberration, which occurs in accordance with variation in the thickness of a cover layer from the surface of the optical disc 11 to the recording layer, and variation in the thickness of a spacer layer between the recording layers. As the aberration correction device 15, for example, a beam expander, a liquid crystal device or the like can be used. When the beam expander is used, an actuator such as a stepping motor or the like drives the beam expander to correct the aberration. When using the liquid crystal device, an analog driving signal, a PWM (Pulse Width Modulation) signal or the like is used to adjust an amount of aberration correction of a liquid crystal. The embodiment will be described when using the beam expander as the aberration correction device 15 as an example.

The photodetector 17 is provided with, for example, a light receiving element having a plurality of light receiving portions. For example, a four-divided light receiving element is used. The four-divided light receiving element has four light receiving portions, which are divided into four in a direction along the recording track of the above optical disc 11 (a tangential direction) and in a direction orthogonal to the recording track (a radial direction). The light reflected by the optical disc 11 is received by each of the four light receiving portions, and is separately converted into electric signals to be output.

Each signal obtained through photoelectric conversion is supplied to an error signal generator 21 as a photodetection signal. The error signal generator 21 generates a focus error signal (FE) and a tracking error signal (TE). The focus error signal (FE) and the tracking error signal (TE) represent the error between the recording/reading target position on the optical recording medium and the recording/reading position of the optical pickup.

The focus error signal FE is generated by, for example, an astigmatic focus-error detection method. In other words, the focus error signal FE is generated as deviation from the focal position of the objective lens caused by the astigmatism of an optical system. The tracking error signal TE is generated by, for example, a DPD (Differential Phase Detection) method. In other words, the tracking error signal TE is generated by difference in phases of the received signals, which are received by the diagonally opposite light receiving portions of the four-divided light receiving portions.

The focus error signal FE generated by the error signal generator 21 is supplied to a gain-variable amplifier 22 (hereinafter, simply referred to as “amplifier”). That is, the amplifier 22 is configured so that the gain of the amplifier 22 is adjustable by a gain correction signal from a gain set portion 27. The gain set portion 27 may be provided with a gain table set in advance and/or a gain correction value calculating portion.

The amplifier 22 amplifies the focus error signal FE, and an amplified focus error signal (FEg) is supplied to a phase compensator 23. The phase compensator 23 compensates the amplified focus error signal (FEg) in phase. A signal after phase compensation is supplied to a loop switch 24, which switches a focus servo loop between an open state and a closed state.

The focus error signal (FEg) is also supplied to a timing controller 26. The timing controller 26 generates various timing signals related to a focus jump, the switching of the servo loop, the change of the gain, drive for aberration correction and the like, on the basis of the focus error signal (FEg) to make timing adjustment. The timing controller 26 has a comparator capability for analyzing variation in the focus error signal (FEg), detecting a zero-cross point and comparing a detected value with a predetermined value. The timing controller 26 is provided with a timer (not illustrated) for measuring time, and a defect detector. The timing controller 26 operates under the control of the CPU 25, which controls the entire device.

The timing signal generated by the timing controller 26 in response to a signal (Trig) for commanding the switching of the accessed recording layer for the purpose of recording or reading, on the other hand, is supplied to a jump signal generator 28. The jump signal generator 28 generates a driving signal (Fdrv) for varying the focusing position, and supplies the driving signal (Fdrv) to the loop switch 24. The driving signal (Fdrv) includes an acceleration signal and a deceleration signal for commanding the acceleration and deceleration of changing the focusing position.

The loop switch 24 switches between the signal from the phase compensator 23 after the phase compensation and the driving signal (Fdrv) on the basis of a loop selection signal (Fopen) from the timing controller 26, and supplies one of them to the driver circuit 18.

The timing controller 26 supplies a gain change signal (Ecnt) for changing and adjusting the gain of the amplifier 22 to the gain set portion 27, under the control of the CPU 25. The gain change signal (Ecnt), for example, includes an aberration correction count value described later on. The timing controller 26 supplies the timing signal of the aberration correction to an aberration-correction driving signal generator 29. The aberration-correction driving signal generator 29 generates an aberration-correction driving signal (Edrv) in response to the timing signal, and supplies the signal to the driver circuit 18.

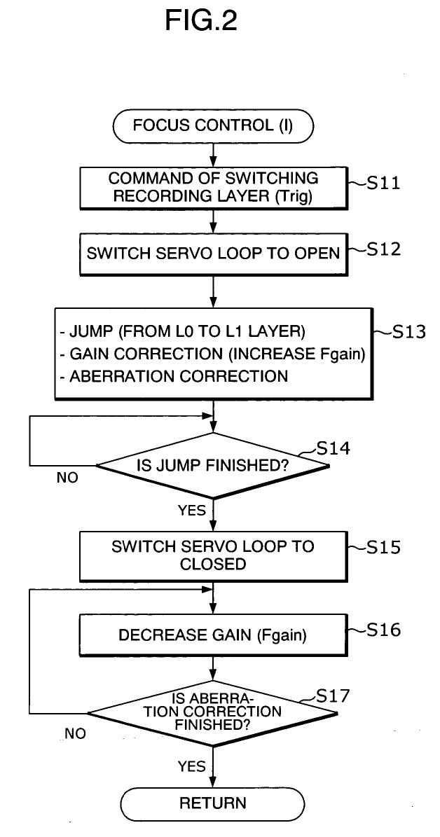

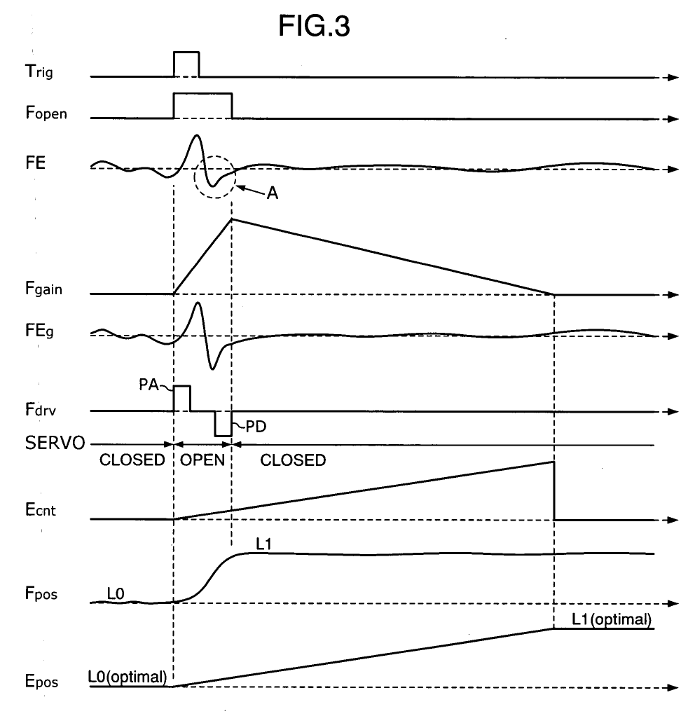

The operation of the focusing control device 10 (hereinafter, also referred to as “focus control (I)”) will be hereinafter described with reference to a flow chart shown in FIG. 2 and a timing chart shown in FIG. 3. This embodiment will be described with taking a double-layer optical disc having two recording layers as an example. In other words, the optical disc 11 has the first recording layer (L0 layer) and the second recording layer (L1 layer).

When the CPU 25 issues the recording layer switching command (Trig) (step S11), the timing controller 26 issues the signal (Fopen) which instructs the focus servo loop to be an open state. The loop switch 24 switches the focus servo loop to the open state in response to the signal (step S12).

As described above, the residual aberration due to the time delay of aberration correction decreases the gain for focus error. In other words, the amplitude of the S-shaped waveform of the focus error signal from the error signal generator 21, that is, the focus error signal (FE) before the gain correction (gain adjustment) decreases at a point in time when the focusing position is transferred to the target recording layer (an A portion shown by an arrow in FIG. 3). Since this point in time is timing for closing the focus servo, decrease in the amplitude of the focus error signal (FE) tends to cause deviation in timing, and makes the interlayer jump sensitive to external perturbations. There occur various problems that the focus cannot be pulled-in into the target recording layer at worse, and the like.

In the embodiment, the amplifier 22 corrects the gain of the focus error signal (FE), and the focusing position is controlled with the use of the focus error signal after the gain correction (that is, FEg). As schematically shown in FIG. 3, the gain correction value (Fgain) keeps on increasing from the start of a focus jump to the end thereof. Thus, the gain increases relatively steeply. The gain correction (increase in Fgain) is carried out in accordance with the gain table, which is set in advance and provided in the gain set portion 27.

To be more specific, after the servo loop is switched to the open state (step S12) a focus jump from the L0 layer to the L1 layer is started. The above gain correction (increase in Fgain) is started, and the beam expander (i.e., aberration correction device) 15 is actuated to carry out the spherical aberration correction (step S13). The pulse count value (Ecnt) of the stepping motor for driving the beam expander 15 is supplied to the gain set portion 27.

The driving signal (Fdrv) for the focus jump is generated on the basis of the focus error signal (FEg) after the gain correction. The driving signal (Fdrv), as described above, includes an acceleration signal pulse (PA) for driving the focusing position with acceleration, and a deceleration signal pulse (PD) for driving the focusing position with deceleration.

Then, whether or not the focus jump is finished is determined (step S14). The timing controller 26 carries out the determination based on the focus error signal (FEg). When the focus jump is determined not to be finished, the operation of step S13 is kept on. When the focus jump is determined to be finished, the loop switch 24 switches the focus servo loop to the closed state in response to a falling edge of the signal (Fopen) from the timing controller 26 (step S15).

Then, the gain correction value (Fgain) of the amplifier 22 is gradually decreased. The gain (Fgain) decreases in proportion to the pulse count value (Ecnt) of the stepping motor for driving the beam expander 15 (step S16). In this state, the spherical aberration correction is still continued by the drive of the beam expander 15. Thus, as shown in FIG. 3, the position of the beam expander 15 (Epos) varies in accordance with the pulse count value (Ecnt) of the stepping motor.

Then, whether or not the aberration correction is finished is determined (step S17). When the aberration correction is determined to be finished, the operation comes out of the present routine. When the aberration correction is finished, the aberration correction is adjusted to the optimal value (L1 (optimal)) of the target recording layer (L1 layer).

It is preferable that the gain correction is completed at a point in time when the drive of the beam expander 15 is finished, and the gain correction value decreases in such a manner as to be zero (i.e., the gain becomes equal to a value without the gain correction) at that point in time.

In this embodiment, as described above, the gain correction and the aberration correction are started simultaneously with the start of the switching of the recording layer. The gain keeps on increasing from the start of the focus jump to the end thereof. In other words, increase in the gain is finished in a period shorter than time necessary for the aberration correction (i.e., the response time of the aberration correction device), and the gain is gradually decreased after the end of the focus jump.

According to the embodiment, since the gain correction properly maintains the servo gain during the interlayer jump, even if the residual aberration exists, the interlayer jump is carried out in sensitively to the external perturbations and stably. Since the servo gain can be properly maintained till the aberration correction is completed, it is possible to stably carry out the focus servo control with high precision.

Especially, since the focus jump is firstly carried out to reach the target position, the embodiment has the advantage that address information and the like can be obtained quickly.

The embodiment was described in the case of the focus jump from the L0 layer to the L1 layer, but the description is exactly alike in the case of a focus jump from the L1 layer to the L0 layer. The embodiment was described for the double-layer disc, but can be applicable to an optical disc having a plurality of recording layers. In other words, the invention is applicable to the case of a jump from one of the recording layer to any of the other recording layers, out of the plurality of recording layers.

### SECOND EMBODIMENT

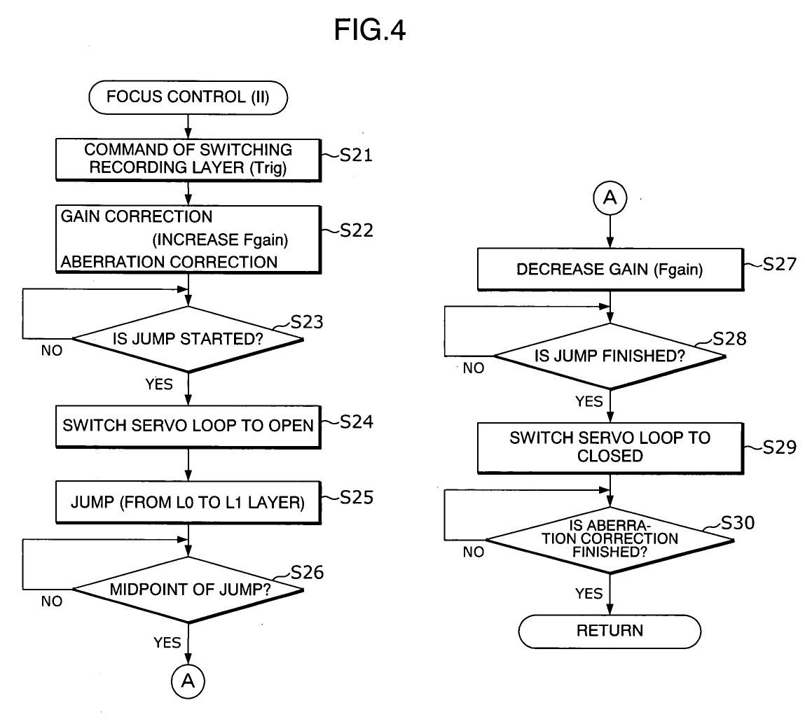

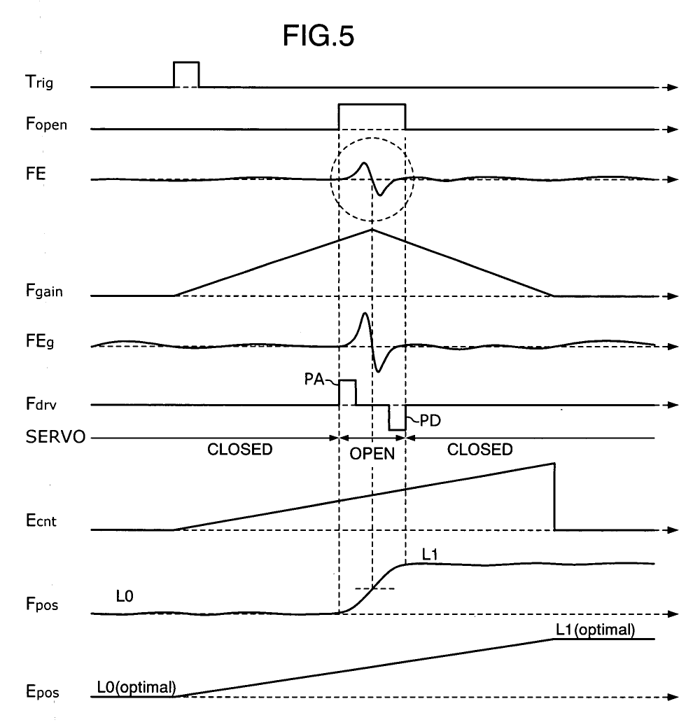

The operation of a focusing control device 10 (hereinafter, also referred to as “focus control (II)”) will be hereinafter described in detail with reference to a flow chart shown in FIG. 4 and a timing chart shown in FIG. 5. The configuration of the focusing control device 10 is similar to that of the first embodiment.

When a CPU 25 issues a recording layer switching command (Trig) (step S21), a beam expander (aberration correction device) 15 is actuated to start spherical aberration correction (step S22), simultaneously with starting the gain correction described above (increase in Fgain). A gain table set in advance and a gain calculating portion, which are provided in a gain set portion 27, correct gain (increase Fgain) in response to a pulse count value (Ecnt) of a stepping motor for driving the beam expander 15.

A timing controller 26 determines the start of a focus jump, based on whether or not time has reached the midpoint of time necessary for the aberration correction of the beam expander 15 (or time necessary to switch a recording layer) (step S23). In other words, in this embodiment, the focus jump is started at a point in time when almost half of the time necessary for the aberration correction has elapsed.

When it is determined that the focus jump has been started, the timing controller 26 issues a signal (Fopen), which instructs a focus servo loop to be in an open state. The loop switch 24 switches the focus servo loop to an open state in response to the signal (step S24).

After switching the servo loop to the open state, the focus jump is started (step S25). The driving signal (Fdrv) of the focus jump is generated on the basis of a focus error signal (FEg) after the gain correction. The driving signal (Fdrv) includes an acceleration signal pulse (PA) and a deceleration signal pulse (PD).

Then, the timing controller 26 determines whether or not the focus jump has reached the midpoint thereof (step S26). The timing controller 26 carries out that determination on the basis of, for example, the focus error signal (FEg). For example, the zero cross point of the S-shaped waveform of the focus error signal (FEg) is detected in order to determine whether or not the focus jump has reached the midpoint.

When the focus jump is determined to have reached the midpoint thereof, the gain correction value (Fgain) of the amplifier 22 is gradually decreased (step S27). The gain (Fgain) is decreased in response to the pulse count value (Ecnt) of the stepping motor for driving the beam expander 15.

In this embodiment, the gain is switched (i.e., switched from increase to decrease) at a point in time when the focus jump reaches the midpoint thereof. The switching of the gain, however, may be carried out at any point in time from the start of the focus jump to the end thereof.

Then, whether or not the focus jump is finished is determined (step S28). The determination is carried out based on the corrected focus error signal (FEg) by, for example, detecting an S-shaped waveform. When the focus jump is determined to be finished, the loop switch 24 switches the focus servo loop to a closed state, in response to a falling edge of the signal (Fopen) from the timing controller 26 (step S29).

Then, whether or not the aberration correction is finished is determined (step S30). When the aberration correction is determined to be finished, operation comes out of the present routine.

It is preferable that the gain correction is completed when the drive of the beam expander 5 is finished, and the gain correction value is decreased in such a manner as to be zero (i.e., the gain equal to a value without the gain correction) at that point in time.

According to the embodiment, since the gain correction properly maintains the servo gain during the interlayer jump, even if the residual aberration exists, the interlayer jump is carried out insensitively to the external perturbations and stably. Since the servo gain can be properly maintained till the aberration correction is completed, it is possible to stably carry out the focus servo control with high precision. Especially, since it is unnecessary to steeply vary an amount of the gain correction during the focus jump, the maximum value of the amount of gain correction becomes small, and hence the focusing control device 10 according to the embodiment has the advantage of superior stability.

### THIRD EMBODIMENT

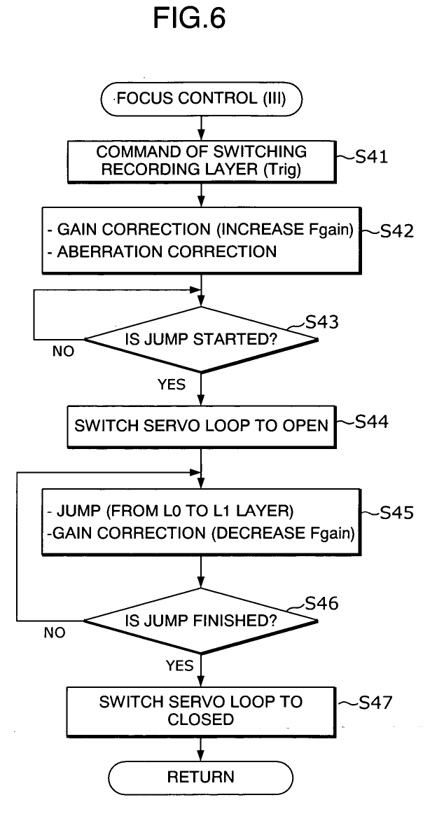

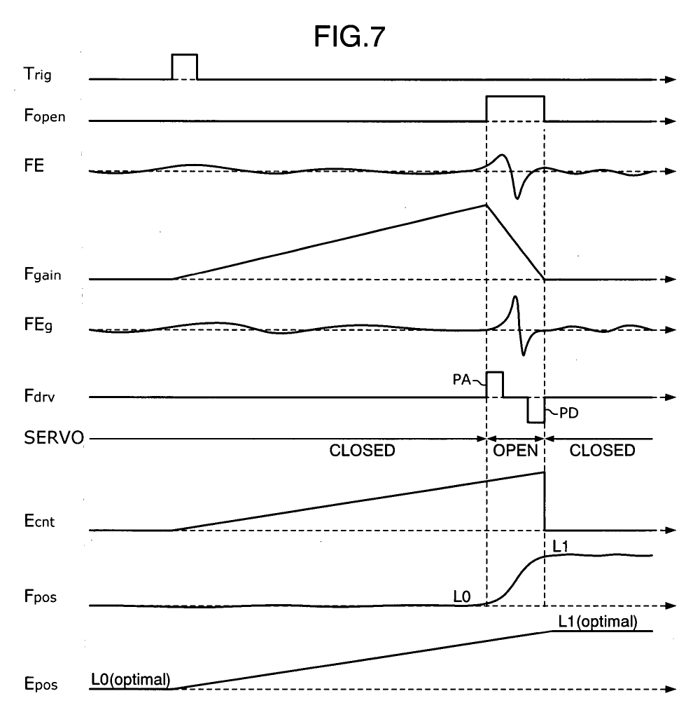

The operation of a focusing control device 10 (hereinafter, also referred to as “focus control (III)”) will be hereinafter described in detail with reference to a flow chart shown in FIG. 6 and a timing chart shown in FIG. 7. The configuration of the focusing control device 10 is similar to that of the first embodiment.

When a CPU 25 issues a recording layer switching command (Trig) (step S41), a beam expander 15 is actuated to start spherical aberration correction (step S42), simultaneously with starting gain correction (increase in Fgain). A gain table set in advance and a gain calculating portion, which are provided in a gain set portion 27, correct gain (increase Fgain) in response to a pulse count value (Ecnt) of a stepping motor for driving the beam expander 15.

A timing controller 26 determines the start of the focus jump, by subtracting time necessary for the focus jump from time necessary for the aberration correction of the beam expander 15 (the response time of an aberration correction device) (step S43). In other words, the focus jump is started so that the end point of the aberration correction of the beam expander 15 becomes almost equal to the end point of the focus jump. The end point of the aberration correction may not be always equal to the end point of the focus jump, as long as difference in these end points is within a predetermined range.

When the focus jump is determined to be started, the timing controller 26 issues a signal (Fopen) which instructs a focus servo loop to open. A loop switch 24 switches the focus servo loop to an open state in response to the instruction signal (step S44).

After switching the servo loop to the open state, the focus jump is started. At the same time, the gain correction value (Fgain) of the amplifier 22 is decreased (step S45). A driving signal (Fdrv) for the focus jump is generated on the basis of a focus error signal (FEg) after the gain correction. The gain correction is completed at a point in time when the drive of the beam expander 15 is finished, and the gain correction value is decreased so as to be equal to a gain value without the gain correction at that point in time. Therefore, the gain (Fgain) is decreased relatively steeply.

Then, the timing controller 26 determines whether or not the focus jump is finished (step S46). The timing controller 26 carries out the determination based on the S-shaped waveform of the focus error signal (FEg). When the focus jump is determined to be finished, the loop switch 24 switches the focus servo loop to a closed state, in response to a falling edge of the signal (Fopen) from the timing controller 26 (step S47), and then operation comes out of the present routine.

According to the embodiment, since the gain correction properly maintains the servo gain during the interlayer jump, even if the residual aberration exists, the interlayer jump is carried out insensitively to the external perturbations and stably. Since the servo gain can be properly maintained till the aberration correction is completed, it is possible to stably carry out the focus servo control with high precision. Especially, in switching recording layers after operation which needs time for access to recorded data and the like, the aberration correction is carried out in parallel with the operation in advance, and then the focus jump is carried out. Therefore, the focusing control device 10 according to the embodiment has the advantage of time reduction.

In this embodiment, the focus jump is so started that the end point of the aberration correction becomes almost equal to the end point of the focus jump. The focus jump, however, may be carried out at any point in time necessary for the aberration correction, namely at any point in time from the start of the aberration correction to the end thereof.

### FOURTH EMBODIMENT

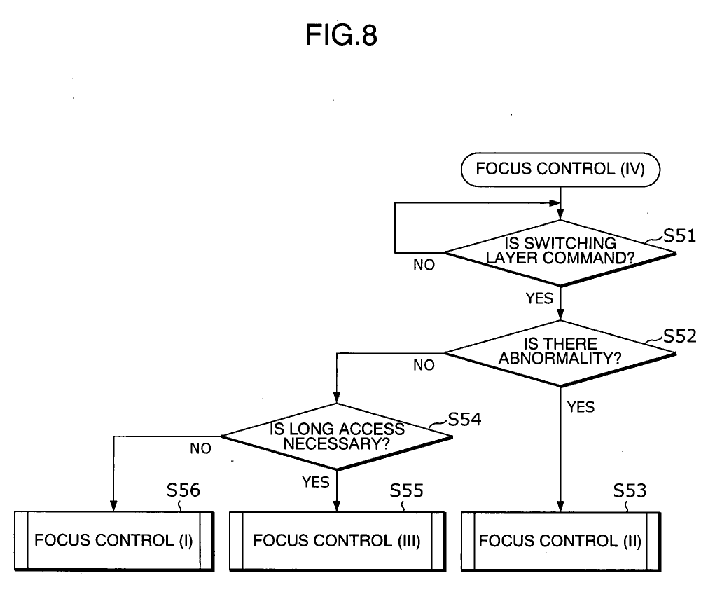

The operation of a focusing control device 10 (hereinafter, also referred to as “focus control (IV)”) will be hereinafter described in detail with reference to a flow chart shown in FIG. 8. The configuration of the focusing control device 10 is the same as that of the first embodiment.

First, a CPU 25 determines whether or not to issue a layer switching command (step S51). After issuing the layer switching command, it is determined whether or not there are various abnormalities in an optical disc 11 (step S52). An abnormality detector provided in the CPU 25 detects and determines the abnormality of the disc. The abnormality of the disc may be determined in the categories, which are necessary for selecting the modes of focus control (i.e., focus control I to III). For example, the defects of the disc such as a surface deflection, a scratch, a stain and the like are set as the categories.

When it is determined that, for example, there is a surface deflection in the disc, the above-described focus control (II) is carried out (step S53). When it is determined that there is no disc abnormality described above, whether an access requiring time such as a long track-search and the like (hereinafter, referred to as “long access”) is necessary or not is determined (step S54).

When it is determined that the long access is necessary, the focus control (III) is carried out (step S55). When the long access is determined to be unnecessary, the focus control (I) is carried out (step S56).

According to the focusing control described above, the optimal focus control mode can be selected, and hence it is possible to stably carry out focus servo control with high precision.

### FIFTH EMBODIMENT

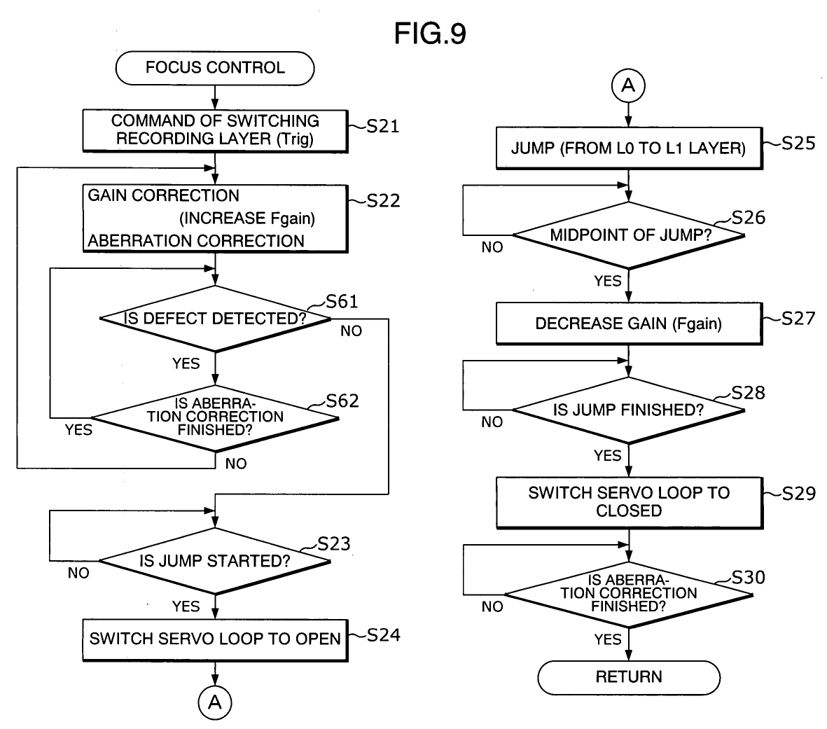

The operation of a focusing control device 10 will be hereinafter described in detail with reference to a flow chart shown in FIG. 9. In this embodiment, focusing control has a processing step to detect a defect, as an example of a disc abnormality, and operation similar to the focus control (II) is carried out.

When a CPU 25 issues a recording layer switching command (Trig) (step S21), a beam expander 5 is actuated to start spherical aberration correction (step S22), simultaneously with starting the gain correction described above (increase in Fgain).

After starting the gain correction and the aberration correction, a defect detector provided in a timing controller 26 detects the defect of a disc such as a scratch, a stain and the like (step S61).

The defect detector in the timing controller 26 detects the defect for predetermined time and/or at predetermined timing and frequency. When the defect detector detects the defect, and the aberration correction is determined to be unfinished (step S62), the gain correction and the aberration correction are continued (step S22). When the aberration correction is determined to be finished (step S62), the detection of the defect is continued (step S61).

When it is determined that the defect detector does not detect the defect (step S61), on the other hand, operation advances to step S23. An interlayer jump is carried out by following procedure from step S23 to step S30, as in the case of the second embodiment.

In the embodiment, as described above, there is a limitation that the focus jump operation is not carried out while the defect is detected. Therefore, there is no failure in, for example, pulling-in a servo into a target recording layer, and hence it is possible to provide an extremely-stable and high-precision focus control device.

In the above embodiments, the execution timing of the focus jump and the rate of change in the gain of the amplifier are adjusted so that a timing when the gain of the amplifier reaches a predetermined gain is within the execution period of the focus jump (within a period of time including the start point and the end point of the focus jump). Or the execution timing of the focus jump and the rate of change in the gain of the amplifier are adjusted so that a timing when the gain correction of the amplifier changes from increase to decrease is within a period of time from the start of the focus jump to the end thereof.

In the embodiments described above, the beam expander is used as the aberration correction device, but another aberration correction device such as a liquid crystal aberration correction device and the like may be used instead. In the case of using the liquid crystal device, for example, a driving signal may be applied to the liquid crystal device in a step-like manner, and an amount of gain correction may be determined in accordance with time measured by a timer. The gain correction may be carried out in consideration of the temperature dependence of the response speed of the liquid crystal device.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Application No. 2003-137260 which is hereby incorporated by reference.

What is claimed is:

1. A control device for executing a focus jump, said focus jump transferring a focusing position of a light beam applied to an optical recording medium having a plurality of recording layers from one recording layer to the other recording layer, said control device comprising:
an error signal generator for generating a positional error signal, said positional error signal representing the error between said focusing position of said light beam and a focusing target position of said optical recording medium;
an amplifier for amplifying said positional error signal;
a focus controller for performing a servo control of said focusing position of said light beam and the control of said focus jump, on the basis of the amplified positional error signal;
an aberration corrector for correcting an aberration of said light beam;
a layer change command generator for generating a layer change command, said layer change command commanding the change of a recording/reading layer from the one recording layer to the other recording layer;
an aberration correction changing portion for changing an aberration correction value of said aberration corrector to an aberration correction value suited for the other recording layer, in response to said layer change command; and
a timing adjuster for increasing a gain of said amplifier to a predetermined gain in response to said layer change command, and for adjusting an execution timing of said focus jump and a rate of change in said gain of said amplifier in such a manner that a timing when said gain of said amplifier reaches said predetermined gain is within the execution time period of said focus jump.

2. The control device according to claim 1, wherein
said timing adjuster starts said focus jump in response to the start of change of said aberration correction value, and adjusts said gain of said amplifier in such a manner that said gain of said amplifier reaches said predetermined gain at a timing when said focus jump is finished.

3. The control device according to claim 1, wherein
said timing adjuster makes said focus jump be carried out in such a manner that said focus jump is finished when the change of said aberration correction value is finished, and adjusts said gain of said amplifier in such a manner that said gain of said amplifier reaches said predetermined gain at a timing when said focus jump is started.

4. The control device according to claim 1, wherein
said timing adjuster makes said focus jump be carried out at a midpoint in time from the start of change of said aberration correction value to the end thereof, and adjusts said gain of said amplifier in such a manner that said gain of said amplifier reaches said predetermined gain at the midpoint of said focus jump.

5. The control device according to claim 1, wherein
said timing adjuster adjusts said execution timing of said focus jump and said rate of change in said gain of said amplifier, on the basis of a response speed, at which said aberration correction value of said aberration corrector is changed to said aberration correction value suited for the other recording layer.

6. The control device according to claim 1, wherein
said timing adjuster decreases said gain of said amplifier in accordance with a response speed of said aberration corrector, after said gain of said amplifier reaches said predetermined gain.

7. The control device according to claim 1, further comprising:
a detector for detecting an abnormality of said optical recording medium,
wherein said timing adjuster adjusts said execution timing of said focus jump and said rate of change in said gain of said amplifier, on the basis of the kind of detected abnormality.
